(19) United States
(12) Patent Application Publication
(10) Pub. No.: US 2010/0181964 A1
(43) Pub. Date: Jul. 22, 2010

(54) WIRELESS POWER DISTRIBUTION SYSTEM AND METHOD FOR POWER TOOLS

(76) Inventors: Mark Huggins, Anderson, SC (US); Robert E. McCracken, Anderson, SC (US); Jason P. Whitmire, Piedmont, SC (US); Mike Hornick, Anderson, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/692,261

(22) Filed: Jan. 22, 2010

Related U.S. Application Data
(60) Provisional application No. 61/146,534, filed on Jan. 22, 2009.
(60) Provisional application No. 61/147,647, filed on Jan. 27, 2009.

(51) Int. Cl. H02J 7/00

(52) U.S. Cl. 320/108

(57) ABSTRACT

A wireless power distribution system and method for power tools. The system includes a power transmitter and a plurality of power harvesters or receivers. The receivers are located in power tools, battery packs that are attachable to and detachable from the power tools, or a device or case that is interfaceable with the power tool or battery pack. The power transmitter transmits radio frequency (“RF”) power signals to the receivers that are within transmission range of the power transmitter. The receivers receive the RF power signals and convert the RF power signals into direct current. The direct current is used to charge a battery, directly power a tool, or both.

### RELATED APPLICATIONS

This application claims the benefit of previously-filed, co-pending U.S. Provisional Patent Application No. 61/146,534, filed Jan. 22, 2009, the entire content of which is hereby incorporated by reference. This application also claims the benefit of previously-filed, co-pending U.S. Provisional Patent Application No. 61/147,647, filed on Jan. 27, 2009, the entire content of which is also hereby incorporated by reference.

### BACKGROUND

The present invention relates to wireless power distribution for power tools. Power tools are generally classified as corded and cordless tools. A corded power tool includes a direct physical and electrical connection to a power source, such as a 120V AC wall outlet, and does not include any integral or detachable power sources (e.g., batteries or battery packs). Some corded tools can also be physically and electrically connected to a DC power source, such as a cigarette lighter. However, corded power tools have limited portability and range of use because of the required direct physical and electrical connection with the wall outlet, DC power source (e.g., a vehicle), or a similar stationary power source.

To improve the portability and range of use of corded power tools, cordless power tools were developed which include a replaceable or rechargeable battery pack. The replaceable and rechargeable battery packs used in cordless power tools, although efficient and capable of supplying the currents required by many power tools, are limited by both the power storage capacity of battery cells, and the requirement of discrete battery chargers for recharging each pack.

### SUMMARY

Embodiments of the invention provide a wireless power distribution system and method for power tools. The system includes a power transmitter and a plurality of power harvesters or receivers. The receivers are located in power tools, battery packs that are attachable to and detachable from the power tools, or a device or case that is interfaceable with the power tool or battery pack (e.g., a battery charger). The power transmitter transmits radio frequency (“RF”) power signals to the power tools that are within transmission range of the power transmitter. The receivers receive the RF power signals and convert the RF power signals into direct current. The direct current is used to charge a battery, directly power a tool, or both.

In one embodiment, the invention provides a wireless power distribution system for tools. The system includes a power transmitter, a power harvester, a battery pack, and a power tool. The power transmitter is configured to transmit a power signal within a first power distribution volume. The power harvester is configured to receive the transmitted power signal and determine whether the received power signal is greater than a threshold power value. The battery pack is configured to be in electrical communication with the power harvester, and is configured to receive power from the power harvester when the received power signal is greater than the threshold power value. The power tool includes a motor and is configured to removably connect to the battery pack. The power tool's motor is configured to be selectively powerable by the battery pack when the received power signal is less than the threshold power value.

In another embodiment, the invention provides a wireless power distribution system for tools. The system includes at least one power transmitter, at least one power harvester, at least one battery pack, and at least one measurement device. The at least one power transmitter is configured to transmit a power signal within a first power distribution volume. The at least one power harvester is configured to receive the power signal and determine whether the received power signal is greater than a power threshold value. The at least one battery pack is configured to be in electrical communication with the at least one power harvester, and the at least one battery pack is configured to receive power from the at least one power harvester when the received power signal is greater than the power threshold value. The at least one measurement device includes one or more sensors, a processor configured to evaluate electrical signals from the one or more sensors, and a digital display configured to display a result of the evaluation by the processor. The at least one measurement device is configured to connect to the at least one battery pack, and the processor and the digital display are configured to be selectively powerable by the at least one battery pack when the received power signal is less than the power threshold value.

In another embodiment, the invention provides a method of wirelessly distributing power to tools. The method includes generating a power signal at a power transmitter, transmitting the power signal within a power distribution volume, and receiving the power signal at a power harvester. The received power signal is compared to a power threshold value and provided to a battery pack when the received power signal is greater than the power threshold value. The method also includes charging the battery pack using the received power signal, selectively connecting the battery pack to a power tool, and selectively powering the power tool using the battery pack when the power signal is below the power threshold value.

Other aspects of the invention will become apparent by consideration of the detailed description and accompanying drawings.

### BRIEF DESCRIPTION OF THE DRAWINGS

FIG. 1 illustrates a wireless power distribution system according to an embodiment of the invention.

FIG. 2 illustrates a corded power transmitter according to an embodiment of the invention.

FIG. 3 illustrates a cordless power transmitter according to an embodiment of the invention.

FIG. 4 illustrates a battery pack according to an embodiment of the invention.

FIG. 5 illustrates a power receiver inside of the battery pack of FIG. 4 according to an embodiment of the invention.

FIG. 6 illustrates a power receiver inside of the battery pack of FIG. 4 according to another embodiment of the invention.

FIG. 7 illustrates a power receiver inside of the battery pack of FIG. 4 according to yet another embodiment of the invention.

FIG. 8 illustrates a power receiver within a neck of a battery pack according to an embodiment of the invention.

FIG. 9 illustrates a power receiver within a lead-acid battery according to an embodiment of the invention.

FIG. 10 illustrates a wireless power distribution system according to an embodiment of the invention.

FIG. 11 illustrates a multi-port battery charger according to an embodiment of the invention.

FIG. 12 illustrates a multi-port battery charger according to another embodiment of the invention.

FIG. 13 illustrates a single-port battery charger according to an embodiment of the invention.

FIG. 14 is a cross-sectional view of the single-port battery charger of FIG. 13.

FIG. 15 illustrates the battery charger of FIG. 13 coupled to a battery pack.

FIG. 16 illustrates a cross-sectional view of the battery charger of FIG. 13 coupled to a battery pack as shown in FIG. 15.

FIG. 17 illustrates a battery pack coupled to a single-port power transceiver.

FIG. 18 illustrates a wireless power distribution system according to an embodiment of the invention.

FIG. 19 is a process for wirelessly powering a tool.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Embodiments of the invention described herein relate to wireless power distribution systems, methods, and devices for power tools. A system includes a power transmitter, a power harvester or receiver, and an antenna. The system is operable to charge, or supply power directly to, a plurality of devices such as battery packs, power tools, battery chargers, test and measurement equipment, vacuum cleaners, outdoor power equipment, and vehicles. Power tools can include drills, circular saws, jig saws, band saws, reciprocating saws, screw drivers, angle grinders, straight grinders, hammers, impact wrenches, angle drills, inspection cameras, and the like. Battery chargers can include wall chargers, multi-port chargers, travel chargers, and the like. Test and measurement equipment can include digital multimeters, clamp meters, fork meters, wall scanners, IR temperature guns, laser distance meters, laser levels, remote displays, insulation testers, moisture meters, thermal imagers, and the like. Vacuum cleaners can include stick vacuums, hand vacuums, upright vacuums, carpet cleaners, hard surface cleaners, canister vacuums, broom vacuums, and the like. Outdoor power equipment can include blowers, chain saws, edgers, hedge trimmers, lawn mowers, trimmers, and the like. The battery pack can also be attachable to and detachable from devices such as electronic key boxes, calculators, cellular phones, head phones, cameras, motion sensing alarms, flashlights, weather information display devices, a portable power source, a digital camera, a digital music player, a self-leveling laser, and multi-purpose cutters. The system can also be used to supply power to industrial power tools used in manufacturing systems such as cellular manufacturing or assembly line manufacturing systems. For example, each corded power tool associated with a work cell in a cellular manufacturing process can be replaced with a cordless power tool that includes a rechargeable battery pack. The battery packs are continuously charged by a power transmitter associated with the work cell. Alternatively, the battery packs are charged when the power tools are not being used.

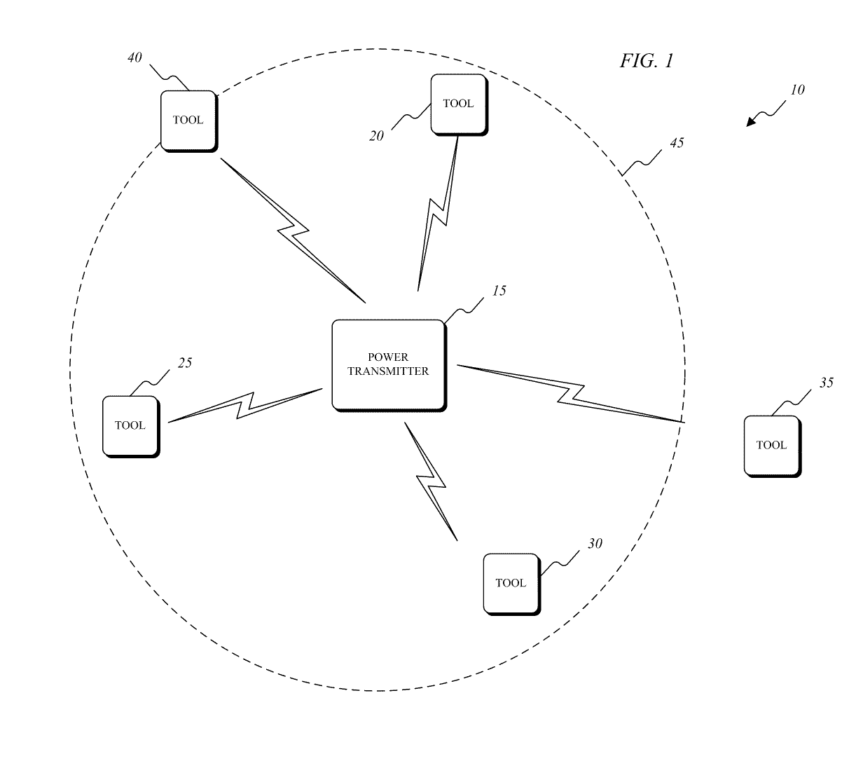

FIG. 1 illustrates a wireless power distribution system 10. The distribution system 10 includes a power transmitter 15 and a plurality of tools 20-40. The tools 20-40 are operable to receive, for example, RF power signals from the power transmitter 15, and convert the power signals into a DC current to provide power directly to the tool, charge a battery pack, or both. The power transmitter 15 has a first transmission range 45 which is dependent upon, among other things, the strength of the power transmitter 15 and the power requirements of the tools 20-40, as well as environmental factors such as walls or surfaces through which the signals must propagate. Although the transmission range 45 is illustrated two-dimensionally, the transmission range of the power transmitter is a three-dimensional transmission or distribution volume. In some embodiments, the power distribution system 10 transmits power in a manner similar to that disclosed in U.S. Patent Publication No. 2007/0191074, titled “Power Transmission Network and Method,” and U.S. Patent Publication No. 2007/0298846, titled “Wireless Power Transmission,” the entire contents of both of which are hereby incorporated by reference. A tool must be within the first transmission range 45 to receive RF power signals from the power transmitter 15 that are above a first threshold value (e.g., have sufficiently strong signals to power the tool or charge a battery). The tools 20, 25, and 30 are within the first transmission range 45 of the power transmitter 15, and receive sufficient power from the RF power signals to power one or more features or functions of the tools, or charge their battery packs. Tool 35 is located outside of the first transmission range 45 and, therefore, receives insufficient power from the RF power signals to operate the tool or charge its battery pack. Tool 40 is located at an outer portion of the first transmission range 45 and may experience intermittent power reception as a result.

In some embodiments, the tools 20-40 include a threshold circuit for determining whether the RF power signals being received are above the first threshold value. If insufficient RF power signals are being received and their battery packs are depleted, the tools 20-40 are rendered inoperable, or the tools 20-40 enter a low-power mode in which the battery pack is charged (e.g., trickle charged). Each tool is then inoperable until the RF power signals are above the threshold, or the battery pack has been charged. In other embodiments, the tools 20-40 are operable when receiving RF power signals below the first threshold value. For example, when receiving RF power signals below the threshold value, features or functions of the tools 20-40 can be disabled, such as a display, to conserve power or limit power requirements. Although the first transmission range 45 is circular in FIG. 1, the actual range of the power transmitter 15 can vary based on the power requirements of the tools 20-40 and the transmission strength of the RF power signals, as described above, and can take on different shapes or distribution patterns (e.g., a directed power distribution).

In other embodiments, different wireless power distribution techniques are used. For example, instead of using RF signals to transmit power, resonant coupling can be used in which two devices, which are tuned to the same frequency, exchange energy strongly, but interact weakly with other objects. At a basic level, a resonant coupling wireless power distribution system includes, for example, a first resonant coil in a transmitter and a second resonant coil in a receiver. The transmitter and the receiver are tuned to the same frequency, and the receiver is connected to, for example, a battery pack or one of the plurality of tools 20-40. In some embodiments, the power transmitter is operable to focus or direct transmitted power signals on a single device. For example, the power transmitter is able to communicate with a device or tool to identify the device or tool, and the transmitter is able to focus on a single device or tool (e.g., transmit power at a particular frequency) based on a user selected preference or general priority. In some embodiments, the power transmitter is configured to focus on charging battery packs at an optimal level (e.g., maximum signal strength) before other devices are charged or powered. In other embodiments, the transmitter is configured to provide a maximum signal strength to a tool, such as a drill or saw, which requires a significant level of current to operate. When the tool is not being used, the transmitter provides power signals to other devices.

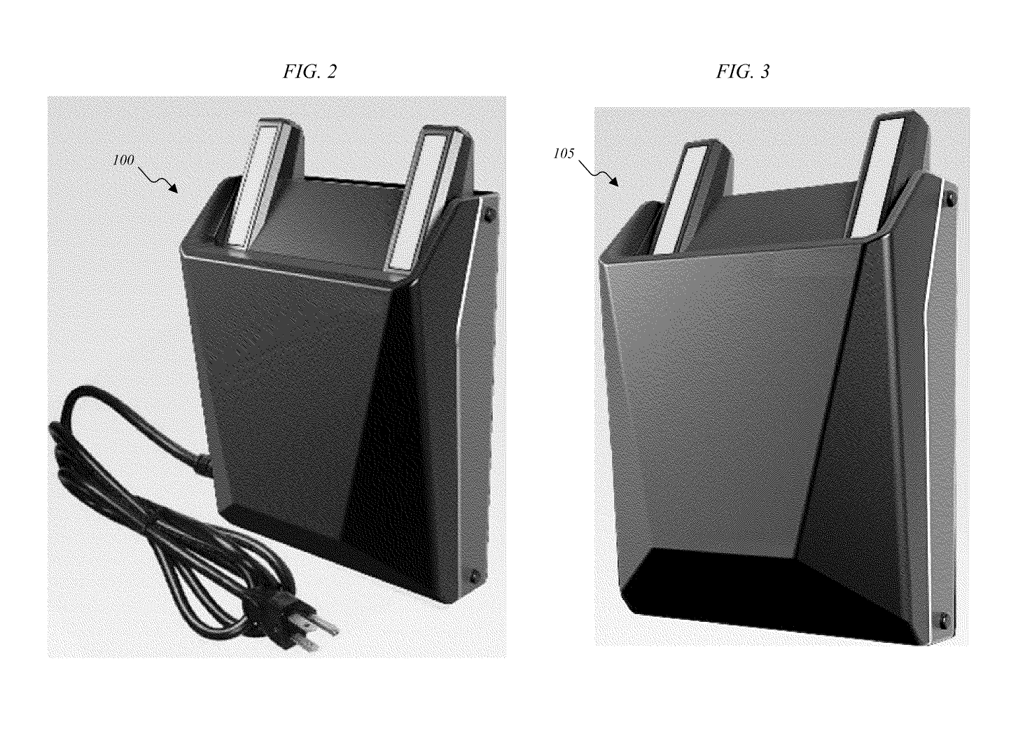

FIGS. 2 and 3 illustrate power transmitters 100 and 105. In some embodiments, the power transmitters 100 and 105 function in a manner similar to those disclosed in U.S. patent application Ser. No. 11/651,818, titled “Pulse Transmission Method,” the entire content of which is hereby incorporated by reference. The power transmitter 100 includes a corded plug for receiving power from a standard 120V AC wall outlet. In other embodiments, the power transmitter 100 is powered from other Mains power sources, such as a 240V AC source or the like. Additionally or alternatively, the power transmitter 100 includes a plug for receiving power from a DC source such as a cigarette lighter in a vehicle. The power transmitter 105 includes an internal power source, such as a plurality of high-voltage battery cells. The power transmitter 105 is portable and can be moved from location to location to provide wireless power to local devices (e.g., devices within the first transmission range 45). In other embodiments, the power transmitter 105 can be connected or integral to a gasoline-powered or similar generator that supplies power to the power transmitter 105. For example, at a remote work site, workers may not have Mains power available to them. In such an instance, the generator provides the power required by the transmitter 105 to provide RF power signals to local devices.

The transmitters 100 and 105 are also capable of being coupled to a variety of surfaces. For example, in some embodiments, the power transmitters 100 and 105 are fastened to a wall using screws or bolts. In other embodiments, the power transmitters 100 and 105 include a magnetic surface (e.g., a magnetic rear surface) that allows the power transmitters 100 and 105 to be magnetically fastened to a metallic surface. The magnetic surface increases the portability of the power transmitters 100 and 105 by allowing a user to detach the power transmitters 100 and 105 from a surface and move them to a different surface (e.g., a different location at a work site). In some embodiments, the power transmitters 100 and 105 include a portable stand that allows the power transmitters 100 and 105 to be placed away from walls (e.g., in the center of a room), or at a location where there are no walls available for the power transmitters 100 and 105 to be fastened. In other embodiments, the power transmitters 100 and 105 are worn by a user. For example, in some work environments, a worker may be required to move beyond the range of a fixed power transmitter (e.g., a power transmitter fastened to a wall). In such an instance, the user can wear a power transmitter as a backpack or fasten the power transmitter to himself or herself using an alternative method (e.g., a strap), and carry the power transmitter. As a result, the worker is able to supply power to tools that are beyond the transmission range of the fixed power transmitter.

In addition to the power transmitters described above with respect to FIGS. 2 and 3, additional power transmission techniques can be used. In one embodiment of the invention, a power transmitter is incorporated into a jobsite radio for charging or powering tools and devices (e.g., digital music players, radios, etc.) within the transmission range of the power transmitter without requiring a physical connection to the jobsite radio. In another embodiment, a power transmitter is incorporated into a job box, truck box, or a tool box, such as those commonly kept in a truck cabin or bed. The box receives power for one or more power transmitters from an AC wall outlet, a DC car adapter, or a battery (e.g., a lead-acid battery) located near or in the box. The power transmitters are attached to or built into one or more walls of the box such that power tools placed inside or on the box receive strong RF power signals for charging the tools' battery packs.

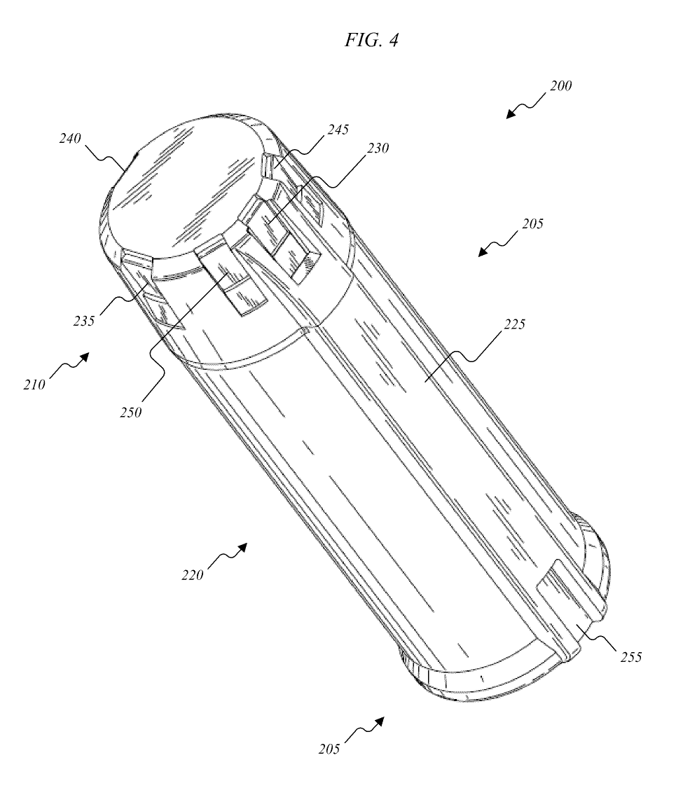

FIG. 4 illustrates a battery pack 200 for receiving power signals from a power transmitter. The battery pack 200 includes a housing 205, a first end portion 210, a second end portion 215, a body portion 220, and a mating rib 225, a power harvester (not shown), and an antenna (not shown). In an exemplary embodiment, the power harvester and the antenna function in a manner similar to the power conversion apparatus disclosed in U.S. Patent Publication No. 2007/0178857, titled “Method and Apparatus for High Efficiency Rectification for Various Loads,” the entire content of which is hereby incorporated by reference. The first end portion 210 includes a low-current discharge terminal 230, a high-current discharge terminal 235, a positive voltage terminal 240, a pack identification terminal 245, and a pack temperature terminal 250. The first end portion 210 is tapered from the body portion 220 to a distal end of the first end portion 210 of the battery pack 200 to facilitate the mating of the battery pack 200 with an end product.

The body portion 220 is cylindrically-shaped and is positioned between the first end portion 210 and the second end portion 215. The diameter of the body portion 220 is large enough to accommodate at least one battery cell, control circuitry, the power harvester, and the antenna. The power harvester and the antenna are located in the first end portion 210, the second end portion 215, or the body portion 220 of the battery pack 200. Alternatively, the power harvester is located in the first, second, or body portions, and the antenna extends longitudinally from the first end portion 210 to the second end portion 215, or circumferentially about the cell or housing 205 of the battery pack 200.

The mating rib 225 extends longitudinally from the first end portion 210 to the second end portion 215, and prevents the battery pack 200 from rolling when the battery pack is inserted in, or otherwise coupled to, an end product. The mating rib 225 at least partially surrounds one of the plurality of terminals, and is tapered at the first end portion 210 to facilitate the mating of the battery pack with an end product. The second end portion 215 includes a recess 255 for securely attaching the battery pack 200 to an end product. In some embodiments, the mating rib 225 is located at a different position on the housing 205, such that the mating rib 225 does not at least partially surround one of the plurality of terminals. In other embodiments, the battery pack 200 can include multiple mating ribs positioned symmetrically about the housing 205 to further secure the battery pack 200 to an end product and prevent rolling. In some embodiments, the housing is, for example, sonically-welded together and is waterproof. The battery pack 200 includes additional components (e.g., a processor, control switches, and the like) and functions similar to those described in U.S. Provisional Patent Application No. 61/147,647, filed on Jan. 27, 2009 and titled “Battery Pack with High and Low Current Discharge Terminals,” the entire content of which was previously incorporated by reference. Additionally, although the battery pack 200 is illustrated as a single-cell battery pack, other battery packs can be used in the power distribution system that include a plurality of battery cells (e.g., 2-8 battery cells), and can have any of a variety of configurations or form factors. For example, some battery packs are brick-shaped, square-shaped, tower, slide-on, or flat (e.g., a cell-phone battery). Each of these battery packs also includes, for example, a power harvester or power harvester board which includes one or more antennas.

The battery pack 200 is operable to provide power to a power tool via the low-current discharge terminal 230, the high-current discharge terminal 235, or both. In some embodiments, the battery pack 200 provides direct current from the RF power signals directly to the power tool through the low-current discharge terminal 230. In other embodiments, the battery pack 200 provides power to the power tool through the high-current discharge terminal 235 (e.g., from a charged battery cell) and through the low-current discharge terminal 230 (e.g., direct current from the RF power signals) at the same time to power different features or functions of the power tool.

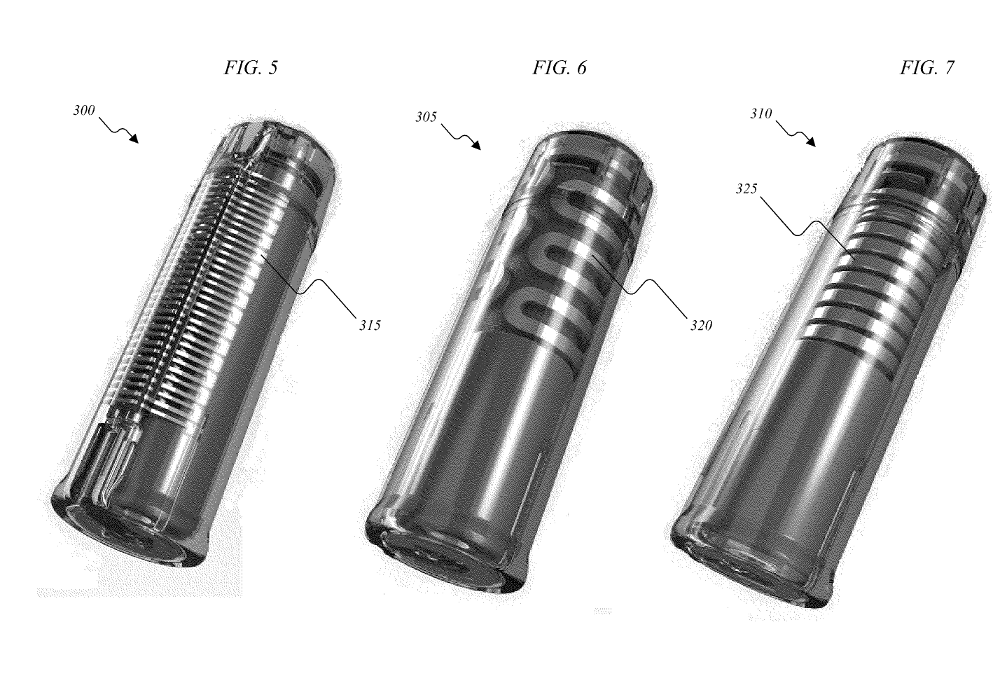

FIGS. 5-7 illustrate battery packs 300, 305, and 310 that are operable to receive RF power signals from the power transmitters. The illustrated battery packs 300-310 are 4V lithium-ion (“Li-Ion”) battery packs. However, in other embodiments, the battery packs 300-310 can have different voltages (e.g., 8V, 12V, 16V, 18V, 24V, 28V, 36V, 48V, etc.), chemistries (e.g., NiMH, Li, Lead-acid, Ni—Cd, etc.), shapes, or sizes. The battery packs 300-310 include at least one circuit and at least one of a plurality of types of antennas for receiving the RF power signals from the power transmitter. For example, FIG. 5 illustrates the use of a Mohawk circuit 315, FIG. 6 illustrates the use of a flex circuit 320, and FIG. 7 illustrates the use of a spiral circuit 325. In other embodiments, different circuits or antennas, such as dipole antennas, Yagi-Uda antennas, horn antennas, patch antennas, fractal antennas, and the like can be used.

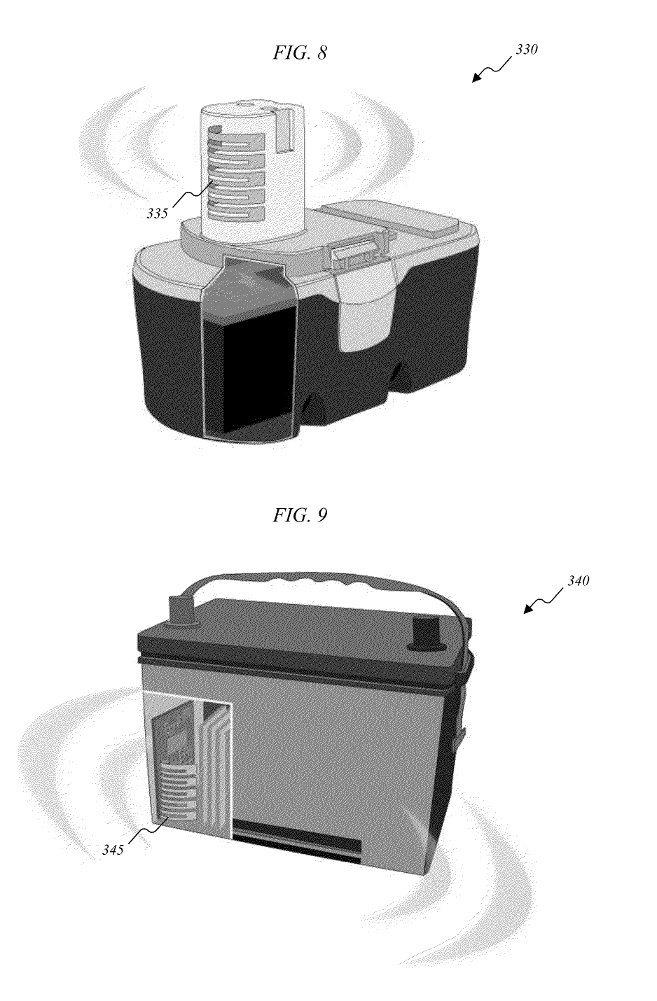

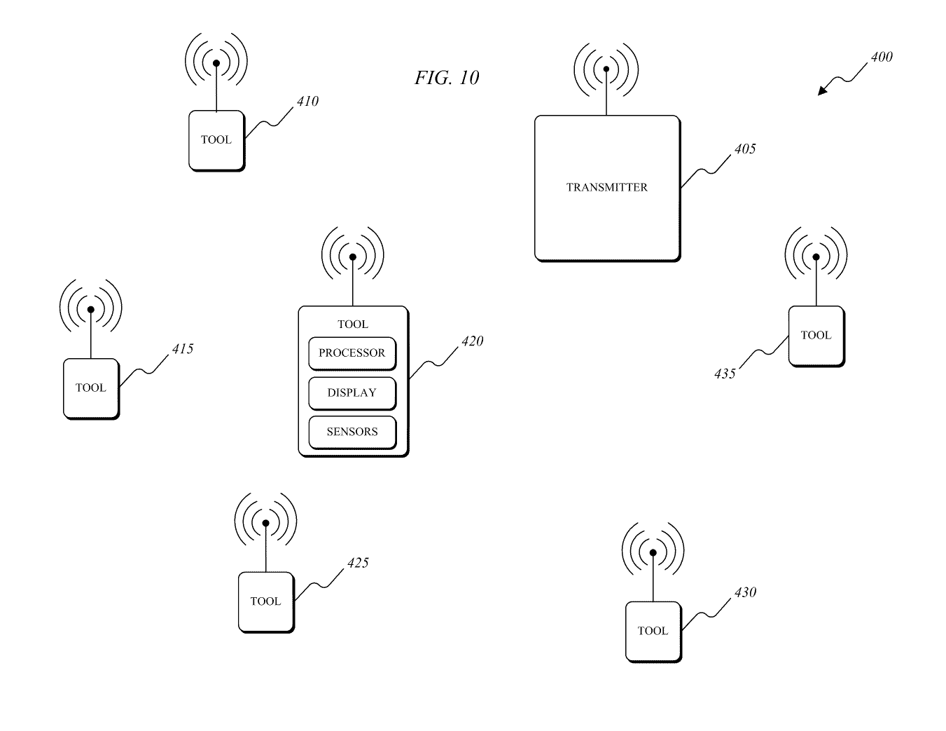

FIGS. 8 and 9 illustrate additional battery packs 330 and 340 which are able to receive power signals from the power transmitters 100 or 105. The battery pack 330 includes an antenna 335 in a neck of the battery pack. In some embodiments, the battery pack 330 is capable of simultaneously discharging stored energy and charging itself with power received at the antenna 335. Similarly, the battery pack 340 includes an antenna 345. The battery pack 340 is, for example, a sealed-lead acid battery for a vehicle. Like the battery pack 330, the battery pack 340 is capable of being charged using power signals received at the antenna 345 and discharging stored energy.

Like the power transmitters described above, the power harvesters or receivers can also be incorporated into a plurality of devices. For example, in one embodiment, a power harvester and an antenna can be incorporated into a tool case. The case is operable to receive and/or hold a tool. The case includes an interface for connecting to the tool when the tool is placed in the case. The case receives the RF power signals and transfers the power to the tool through the interface. As an illustrative example, the battery pack described above with respect to FIG. 4 includes a case that interfaces with the terminals of the battery pack. As a result, the power harvester and antenna do not need to be located within the battery pack, which reduces the size requirements of the battery pack housing. The battery packs are then charged when the battery pack is placed in the case, and is within range of a power transmitter. In other embodiments, the antenna is incorporated into a flexible circuit, and wrapped around the battery cell of the 4V battery pack described above. Alternatively, the antenna is printed on the inside of the battery pack housing.

FIG. 10 illustrates a wireless power distribution system 400 that includes a power transmitter 405 and a plurality of tools 410-435. Systems are known which incorporate radio frequency identification (“RFID”) tags or devices into tools. The RFID tags are used to monitor and track the location of a tool related to a worksite. In the illustrated embodiment, the power transmitter 405 broadcasts RF power signals to the tools 410-435. The RF power signals are used to charge a battery pack or provide power to the tool as described above, as well as to power the RFID tags. In addition to the functions of the RFID tags (e.g., determining location), the tools 410-435 include a communications device, such as a Bluetooth transmitter or similar short-range communication device, to communicate with and provide battery charge information to the power transmitter 405, or a different component of the wireless power distribution system 400. Using the short-range communication, the tools 410-435 provide battery charge information signals that include, among other things, a signal indicating whether a battery pack is being charged, a signal indicating how long the battery pack has been charging, a signal indicating the charge level of the battery pack, signals indicating battery usage statistics, signals indicating the signal strength of the signals received from the power transmitter, signals indicating the proximity of the battery pack to one or more power transmitters, and the like. Additionally, the tools 410-435 provide a signal to the power transmitter 405 or a different component of the power distribution system 400 that indicates a battery pack has been fully charged. When the battery pack for each tool within the transmission range of the power transmitter 405 has been fully charged, the power transmitter 405 and the Bluetooth transmitters enter a sleep or low-power mode. The power transmitter 405 exits the low-power mode when a tool which requires charging comes within transmission range of the power transmitter 405, or a tool that is already within transmission range has a battery pack voltage that drops below a predetermined threshold level (e.g., 90% charge). The Bluetooth transmitters exit the low-power mode when the battery pack voltage level is below a predetermined level, and once again receives RF power signals from the power transmitter. Additionally or alternatively, the power transmitter 405 or Bluetooth transmitter are configured to periodically wake up from the sleep mode (e.g., every 10 minutes, 20 minutes, 30 minutes, etc.), in order to reduce the amount of power used by the distribution system while maintaining each battery pack's charge.

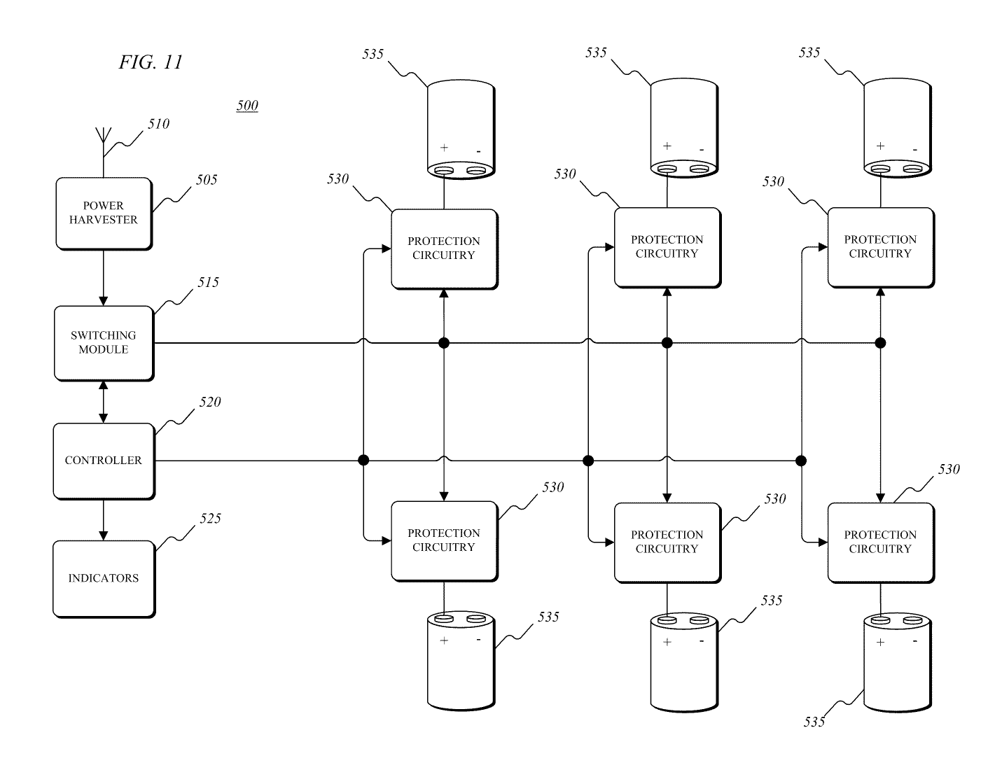

Wireless power distribution systems 10 and 400 also include other devices, such as battery chargers. FIG. 11 illustrates a 6-port battery charger 500 that includes a power harvester 505, an antenna 510 for receiving RF power signals from a power transmitter, a switching module 515, a controller 520, a plurality of indicators 525, a plurality of protection circuits 530, and a plurality of battery packs 535. The harvester 505 can replace or supplement a conventional power supply that receives power from a 120V AC source, or the like. The battery charger 500 uses the power received from the power transmitter to charge the battery packs inserted into the charger 500.

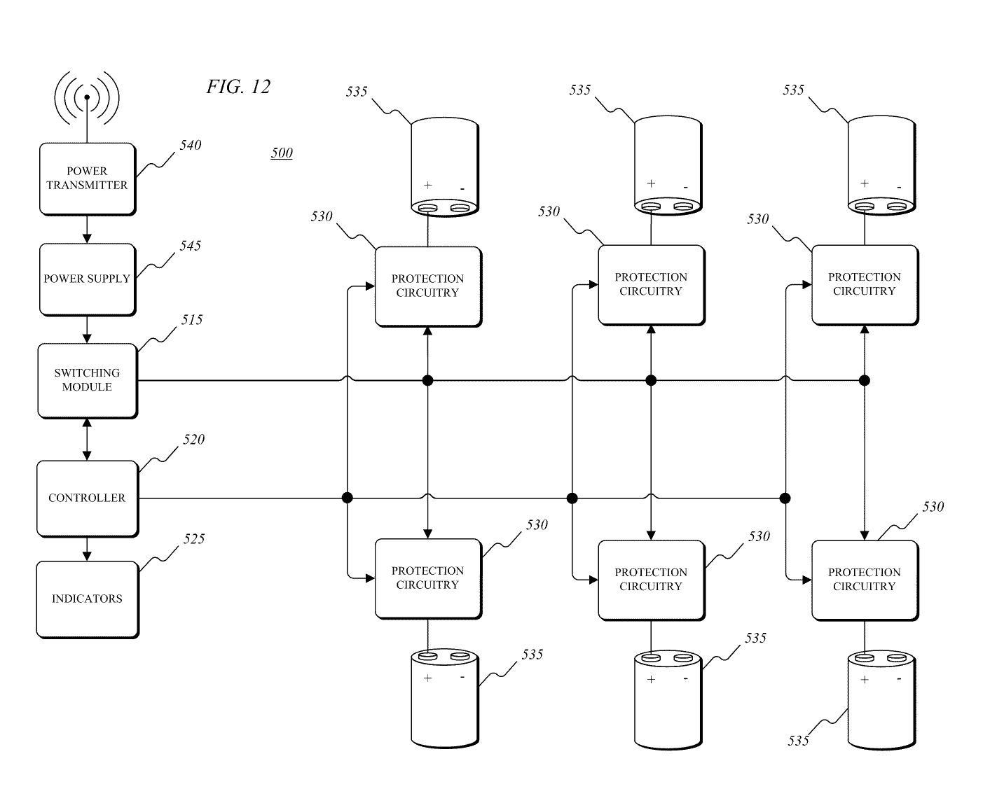

FIG. 12 illustrates an embodiment of the battery charger 500 that includes a power transmitter 540, a power supply 545, the switching module 515, the controller 520, the plurality of indicators 525, the plurality of protection circuits 530, and the plurality of battery packs 535. The battery charger 500 is capable of charging each battery pack inserted into the charging slots of the battery charger (e.g., six battery packs), as well as broadcasting RF power signals to charge other battery packs that include power harvesters, and are located within transmission range of the power transmitter 540.

The battery charger 500 cycles through each of a plurality of charging ports to determine which, if any, of the plurality of charging ports includes a battery pack that requires charging. If the battery charger 500 determines that a charging port includes a battery pack that requires charging, the battery charger 500 switches power from the power harvester 505 or power supply 545 such that a charging current is applied to a single battery pack. If the battery charger 500 determines that no battery packs inserted in the battery charger 500 require charging, the battery charger 500 enters a low-power mode in which the battery charger removes power from each of the charging ports and a display (e.g., liquid crystal display or light emitting diodes) to reduce the power requirements of the battery charger 500. If the battery charger 500 has already charged each of the battery packs inserted into the battery charger 500, and no new battery packs have been inserted into a charging port, the battery charger 500 supplies each inserted battery pack with a trickle charge for a predetermined period of time. The battery charger 500 includes additional functions similar to those described in U.S. patent application Ser. No. 12/555,573, filed on Sep. 8, 2009 and titled “Battery Charger,” the entire content of which is hereby incorporated by reference.

In some embodiments of the invention, adapter devices, which include a power harvester and antenna for receiving RF power signals from the power transmitter, are used to charge conventional rechargeable batteries, such as AA, AAA, C, D, 9V, and the like. The adapters can be stand-alone devices, or can be integrated in an electrical device, such as a radio, a multimeter, a flashlight, a fuel gauge device, etc. Additionally or alternatively, power harvesters and antennas can be incorporated into conventional rechargeable batteries such that the batteries can be continuously charged when within the transmission range of a power transmitter. As such, a power transmitter located in a home or office can be used to charge each household device that receives conventional batteries (e.g., TV remotes, video game controllers, etc.) without having to remove the batteries from the devices.

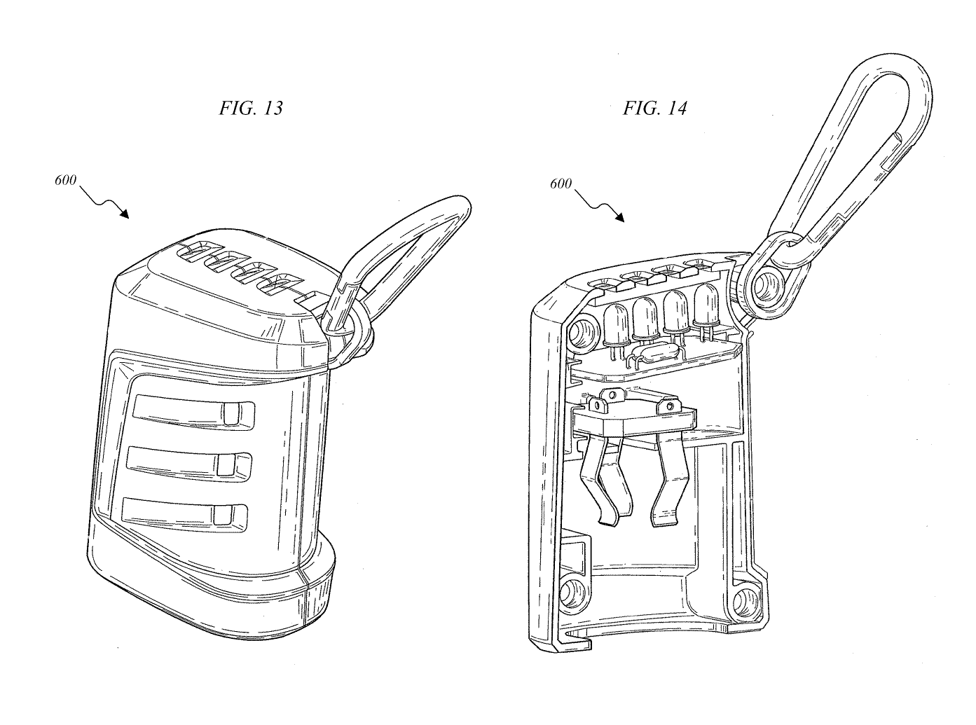

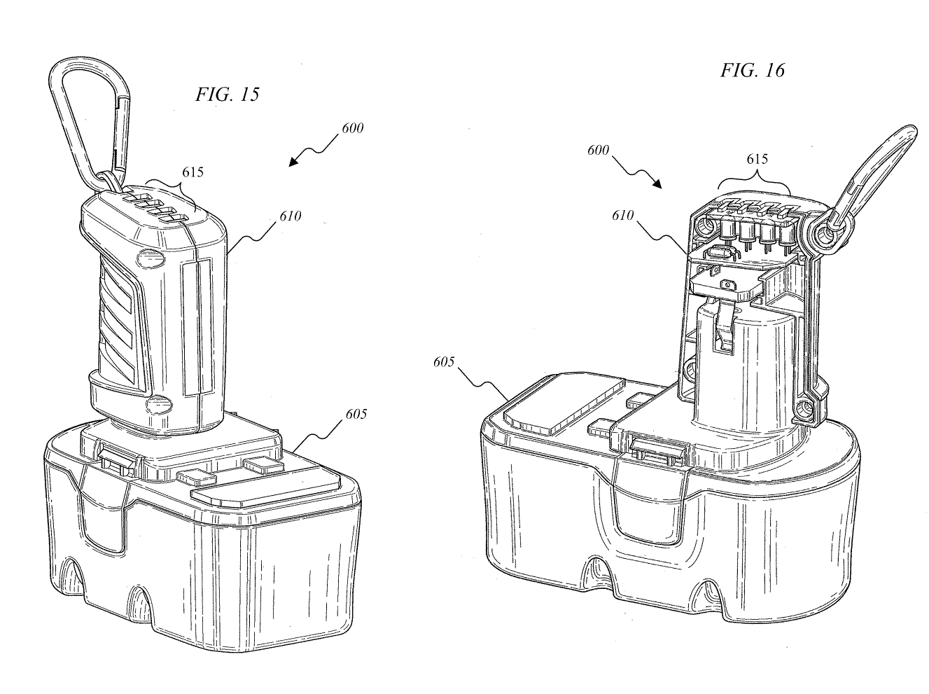

FIGS. 13-16 illustrate a battery testing device 600 that is operable to couple to a conventional battery pack 605 and determine the charge of the battery pack. The battery tester 600 includes a housing 610 and a plurality of indicating devices 615 that indicate to a user the level of charge of the battery pack 605. The battery tester 600 also includes an antenna and a power harvester (not shown). The antenna and the power harvester receive RF power signals from a power transmitter to charge the conventional battery pack 605. The antenna and the power harvester are located within the housing 610 of the battery tester 600. In some embodiments, the antenna is located in a clip ring which is used to carry the testing device 600.

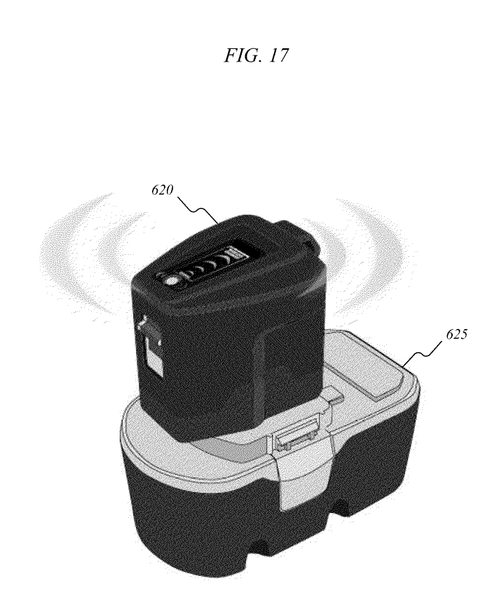

FIG. 17 illustrates a wireless power transceiver 620. In one embodiment, the transceiver 620 is configured to receive power signals at a power harvester using an antenna, as previously described. The received power signals are used to charge a battery pack 625. In another embodiment, the transceiver 620 is configured to transmit power signals. For example, the transceiver 620 is coupled to the battery pack 625 and uses the energy stored in the battery pack to generate power signals. Such an embodiment is particularly beneficial when at a remote worksite and a number of devices require power (e.g., flashlights).

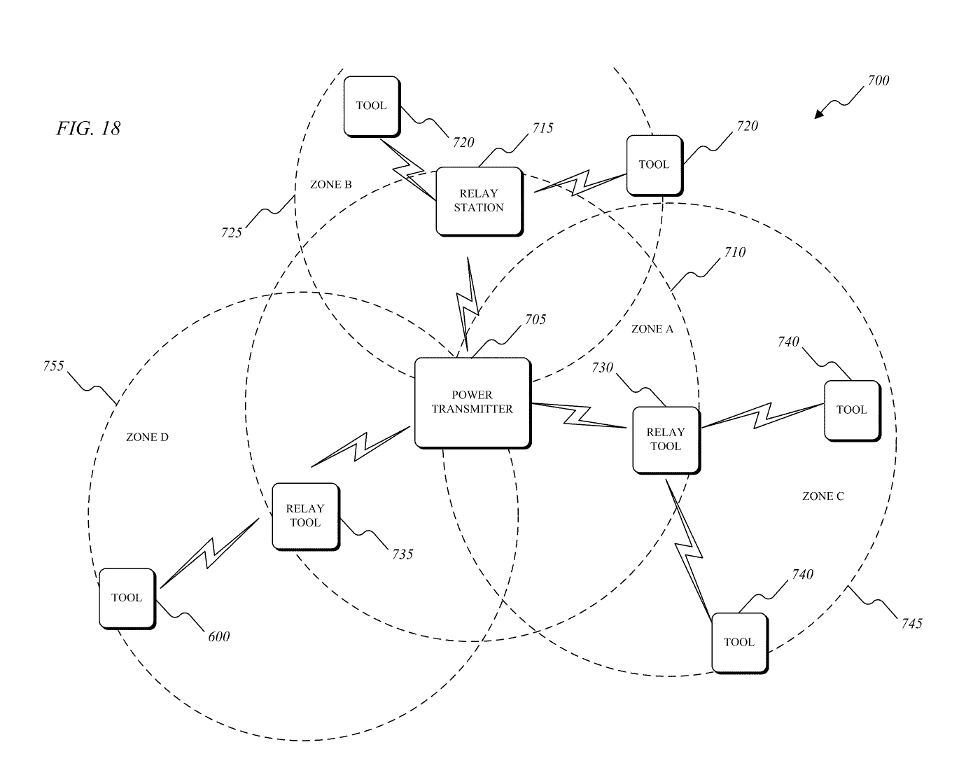

FIG. 18 illustrates a wireless power distribution system 700. The system 700 includes a power transmitter 705 that has a first range 710 for providing wireless power to tools. The first range 710 is identified as zone A in FIG. 18. If a tool is located beyond zone A, the tool does not receive RF power signals from the power transmitter 705 that are above a threshold value, and therefore does not receive enough power to power the tool or charge its battery pack. To extend the range of the power transmitter 705, a relay station 715 is included in the power distribution system 700. The relay station 715 is operable to retransmit the RF signals from the power transmitter 705 to extend the range of the distribution system 700 to tools 720 in zone B 725. The relay station 715 includes, for example, both a transmitter and a receiver. In some embodiments, the relay station 715 is operable to retransmit the RF signals from the power transmitter 705 with a signal strength that is substantially similar to the initial RF power signal broadcast from the power transmitter 705. In other embodiments, the relay station 715 retransmits the RF signals at a lower signal strength than the original signals broadcast from the power transmitter 705. The system 700 also includes relay tools 730 and 735. The relay tools 730 and 735 function in a similar manner to the relay station 715, but the relay tools 730 and 735 are operable to have their batteries charged by the power transmitter 705, to be powered directly by the power transmitter 705, to retransmit RF signals from the power transmitter 705, or combinations thereof. For example, the relay tools 730 and 735 can be charged by the power transmitter 705 while simultaneously retransmitting the RF power signals from the power transmitter 705 to extend the range of the distribution system 700. The relay tool 730 provides RF power signals to tools 740 in zone C 745, and the relay tool 735 provides RF power signals to tool 750 in zone D 755. In such a situation, the relay tools 730 and 735 and the relay station 715 can include multiple transmitters and multiple receivers.

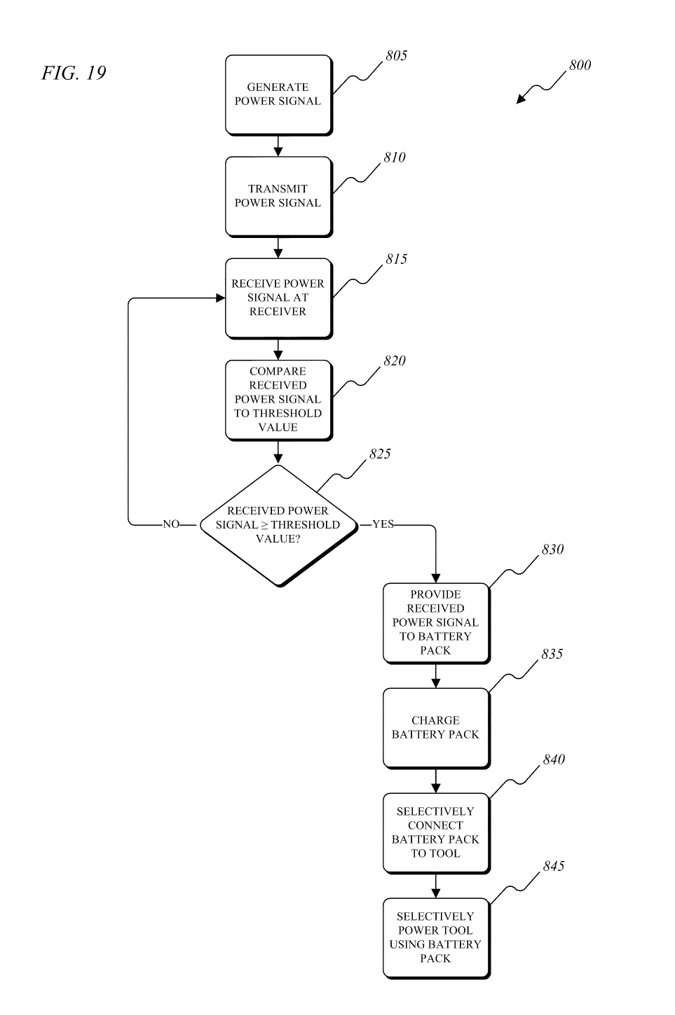

FIG. 19 is a process 800 for wirelessly powering a tool. At step 805, a power transmitter generates a power signal. The power signal is transmitted (step 810) by the power transmitter within a first power distribution volume. If a power receiver is within the first power distribution volume, the power receiver receives the transmitted power signal (step 815). The received power signal is then compared to a threshold power value (step 820). For example, the threshold power value corresponds to a power level which is required to operate or at least partially operate a device. The threshold power value is different for different devices. A device with relatively high power requirements generally has a higher threshold power value. A device with relatively low power requirements generally has a lower threshold power value. If, at step 825, the received power signal is less than the threshold power value, the process 800 returns to step 815 and a newly received power signal is compared to the threshold power value. Although steps 815, 820, and 825 are shown incrementally, the reception and comparison of power signals to the threshold power value is performed continuously in some embodiments. In other embodiments, the reception of a power signal and the comparison of the received power signal to the threshold power value are performed as discrete steps, but are performed at a high sampling rate (e.g., more than 500 samples per second).

If the received power signal is greater than or equal to the threshold power value at step 825, the received power signal is provided to a battery pack (step 830). The battery pack uses the received power signal to charge its battery cell(s) (step 835). The battery pack is then selectively connected to a tool (step 840). In some embodiments, the battery pack continues to charge when connected to a tool. In other embodiments, the battery pack ceases charging when it is connected to the tool. The tool is then selectively powered using the energy stored in the battery pack (step 845). Additionally or alternatively, the tool is selectively powered using received power signals. In some embodiments, the tool is selectively powered using a switch to, for example, connect power to or disconnect power from a motor, a processor, a display, or the like. Due to the power requirements of tools (e.g., power tools, test and measurement devices, etc.) that include such devices, embodiments of the wireless power system in which the battery pack is capable of discharging stored energy and simultaneously recharging the battery cells are beneficial.

Thus, the invention provides, among other things, wireless power distribution systems, methods, and devices for tools. The system includes a power transmitter and a plurality of power harvesters or receivers. The receivers are located in power tools, battery packs that are attachable to and detachable from the power tools, or a device or case that is interfaceable with the power tool or battery pack. The power transmitter transmits RF power signals to the power tools that are within transmission range of the power transmitter. The receivers receive the RF power signals and convert the RF power signals into direct current. The direct current is used to charge a battery, directly power a tool, or both. Various features and advantages of the invention are set forth in the following claims.

What is claimed is:

1. A wireless power distribution system for tools, the system comprising:
a power transmitter configured to transmit a power signal within a first power distribution volume;
a power harvester configured to receive the power signal,
wherein the power harvester is also configured to determine whether the received power signal is greater than a threshold power value;
a battery pack configured to be in electrical communication with the power harvester and receive power from the power harvester when the received power signal is greater than the threshold power value; and
a power tool including a motor and configured to removably connect to the battery pack,
wherein the motor is configured to be selectively powerable by the battery pack when the received power signal is less than the threshold power value.

2. The system of claim 1, further comprising a relay module configured to receive a power signal from the power transmitter and transmit power within a second power distribution volume.

3. The system of claim 2, wherein the relay module is within the power tool.

4. The system of claim 1, further comprising a second power harvester and a battery charger, the second power harvester configured to receive the power signal.

5. The system of claim 4, wherein the second power harvester is connected to the battery charger and the battery charger includes a plurality of charging ports.

6. The system of claim 5, wherein the power signal received by the second power harvester is provided to the battery charger and the battery charger is configured to selectively provide power to the plurality of charging ports.

7. The system of claim 1, wherein the power harvester includes an antenna and is located at least partially within the battery pack.

8. The system of claim 7, wherein the battery pack includes a single lithium-based cell.

9. The system of claim 1, wherein the power tool is one of a saw and a drill.

10. The system of claim 1, wherein the power tool includes a short-range communication device that is powered by the received power signal.

11. A wireless power distribution system for tools, the system comprising:
at least one power transmitter configured to transmit a power signal within a first power distribution volume;
at least one power harvester configured to receive the power signal,
wherein the at least one power harvester is also configured to determine whether the received power signal is greater than a power threshold value;
at least one battery pack configured to be in electrical communication with the at least one power harvester and receive power from the at least one power harvester when the received power signal is greater than the power threshold value; and
at least one measurement device including one or more sensors, a processor configured to evaluate electrical signals from the one or more sensors, and a digital display configured to display a result of the evaluation by the processor, the at least one measurement device configured to connect to the at least one battery pack,
wherein the processor and the digital display are configured to be selectively powerable by the at least one battery pack when the received power signal is less than the power threshold value.

12. The system of claim 11, further comprising a relay module configured to receive the power signal from the power transmitter and transmit power within a second power distribution volume.

13. The system of claim 12, wherein the relay module is within the testing device.

14. The system of claim 11, further comprising a second power harvester and a battery charger, the second power harvester configured to receive the power signal.

15. The system of claim 14, wherein the second power harvester is connected to the battery charger, and the battery charger includes a plurality of charging ports.

16. The system of claim 15, wherein the power signal received by the second power harvester is provided to the battery charger, and the battery charger is configured to selectively provide power to the plurality of charging ports.

17. The system of claim 11, wherein the power harvester includes an antenna and is located at least partially within the battery pack.

18. The system of claim 17, wherein the battery pack includes a single lithium-based cell.

19. A method of wirelessly distributing power to tools, the method comprising:
generating a power signal at a power transmitter;
transmitting the power signal within a power distribution volume;
receiving the power signal at a power harvester;
comparing the received power signal to a power threshold value;
providing the received power signal to a battery pack when the received power signal is greater than the power threshold value;
charging the battery pack using the received power signal,
selectively connecting the battery pack to a power tool, and
selectively powering the power tool using the battery pack when the power signal is below the power threshold value.

20. The method of claim 19, further comprising:
receiving the power signal from the power transmitter at a relay module; and
transmitting power from the relay module within a second power distribution volume.

21. The system of claim 19, further comprising receiving the power signal at a battery charger.

22. The system of claim 21, wherein the battery charger includes a plurality of charging ports.

23. The system of claim 22, further comprising selectively powering the plurality of charging ports using the power signal received at the battery charger.
